(19) United States
(12) Patent Application Publication
(10) Pub. No.: US 2008/0074834 A1
(43) Pub. Date: Mar. 27, 2008

(54) Rereconfigurable structure for panel of portable personal computer

(75) Inventors: Leo Ming Tz Chien, Taipei City (TW); Chia-Shyong Cheng, Taipei City (TW); Yi-Chan Tseng, Taipei City (TW)

Correspondence Address: BRUCE H. TROXELL, SUITE 1404, 5205 LEESBURG PIKE, FALLS CHURCH, VA, 22041, US

(73) Assignee: First International Computer, Inc.

(21) Appl. No.: 11/798,055

(22) Filed: May 9, 2007

(30) Foreign Application Priority Data
May 19, 2006 (TW) 095117889

(51) Int. Cl. G06F 1/16

(52) U.S. Cl. 361/683

(57) ABSTRACT

A reconfigurable structure for a panel of a portable personal computer is adapted to allow the panel of a portable computer housing to be provided with an attachment surface; the panel and a cover plate are respectively provided with first buckling portions and second buckling portions capable of being buckled each other so as to allow the cover plate to be fixed on the panel of the portable computer housing and an article to be held between the cover plate and the panel of the portable computer housing. Whereby, the outlook or the pattern of the panel of the computer can be changed to attain to the requirement that the outlook of the computer is matched up with a personalized desire.

### BACKGROUND OF THE INVENTION

1. Field of the Invention

The present invention relates to a panel of a housing of a portable personal computer, and more particularly to a reconfigurable structure for a panel of a portable personal computer.

2. Brief Description of Related Art

The functions of a portable personal computer are stronger recently and the portable convenience of the computer itself can feed consumers' purchasing appetite. A panel at the back of a display screen of a general portable personal computer is not always reconfigurable; a pattern thereon cannot be changed depending on a user's need or further coupled to other articles.

U.S. Pat. No. 6,125,033 discloses a reconfigurable panel for a portable personal computer, it comprises an cover plate having a first surface and a second surface, in which the first surface is adapted to couple to an outer surface of an enclosure portion of a chassis of the portable personal computer opposing a display thereof and a panel housing that is coupled to the second surface of the cover plate, the different panel housing can be changed depending on a user's need. The panel housing can have cosmetic and/or functional attributes. The panel housing can be made of a durable substance like transparent or color plastic or textile or stainless steel, or coupled to other electronic elements to constitute a solar source.

The patent mentioned above discloses sticking a cover plate to panel housing, and then allowing the cover plate to be coupled to an outer surface of an enclosure portion of a chassis of the portable personal computer so as to meet a user's requirement to change the panel housing. But, the panel housing needs to be stuck to the cover plate first and it can then be coupled to the computer chassis, the coupling structure thereof is rather complex and the production cost is rather consuming. Although it mentions that a gap exists between the cover plate and the panel housing for allowing thin articles like photographs or documents to be placed in, the thin articles placed between the panel housing and the cover plate are not easy to be changed after the housing panel is stuck to the cover plate. Besides, a user easily sees portions of the cover plate without the placed-in thin article through the transparent panel housing; this causes visual portions of the whole panel housing to be not artistic.

### SUMMARY OF THE INVENTION

For simplifying a reconfigurable structure for a panel of a portable personal computer and being convenient for changing thin articles placed on the panel, the present invention is proposed.

The main object of the present invention is to provide a reconfigurable structure for a panel of a portable personal computer, having a simple structure and capable of saving the production cost.

Another object of the present invention is to provide a reconfigurable structure for a panel of a portable personal computer, being convenient for the panel of the computer to be changed with different modeling and pattern.

Still another object of the present invention is to provide a reconfigurable structure for a panel of a portable personal computer, being convenient for allowing a thin article to be placed on the panel and a different thin article to be changed.

Still another object of the present invention is to provide a reconfigurable structure for a panel of a portable personal computer, capable of providing a same type of computer with various profiles to a buyer, increasing the production and the sale amounts of a same basic type of product without needing manufacturing different profiles and modeling of products and saving the product cost greatly to increase the profit of a computer manufacturer.

For attaining to the objects mentioned above, a reconfigurable structure for a panel of a portable personal computer is adapted to couple to the panel of a portable personal computer housing, comprises:

the panel of portable personal computer housing is provided with an attachment surface; the panel is provided with a plurality of first buckling portions;

a cover plate, the dimension thereof is corresponding to the attachment surface; the cover plate is provided with a plurality of second buckling portions respectively corresponding to the first buckling portions; wherein the first buckling portion and the second buckling portion are respectively buckled; the cover plate is positioned on the attachment surface of the panel so as to allowing a user to choose a desired cover plate and the cover plate to be fixed on the panel of the portable personal computer housing. An outlook or pattern of the panel of the computer can be changed to attain to the personal requirement to the computer outlook. And, the computer with a same type and various outlooks is allowed to supply to different purchasers; this can save the production cost greatly and increase the profit of the computer manufacturer.

### BRIEF DESCRIPTION OF THE DRAWINGS

The present invention can be more fully understood by reference to the following description and accompanying drawings, in which:

FIG. 1 is a schematic view, showing a separation state of a reconfigurable structure for a panel of a portable personal computer of a first preferred embodiment according to the present invention;

FIG. 2 is a perspective view, showing a use state of a reconfigurable structure for a panel of a portable personal computer of a first preferred embodiment according to the present invention;

FIG. 3 is a schematic view, showing a separation state of a reconfigurable structure for a panel of a portable personal computer of a second preferred embodiment according to the present invention;

FIG. 4 is a perspective view, showing a use state of a reconfigurable structure for a panel of a portable personal computer of a second preferred embodiment according to the present invention;

FIG. 5 is a schematic view, showing a separation state of a reconfigurable structure for a panel of a portable personal computer of a third preferred embodiment according to the present invention; and

FIG. 6 is a perspective view, showing a use state of a reconfigurable structure for a panel of a portable personal computer of a third preferred embodiment according to the present invention.

### DETAILED DESCRIPTION OF THE PREFERRED EMBODIMENTS

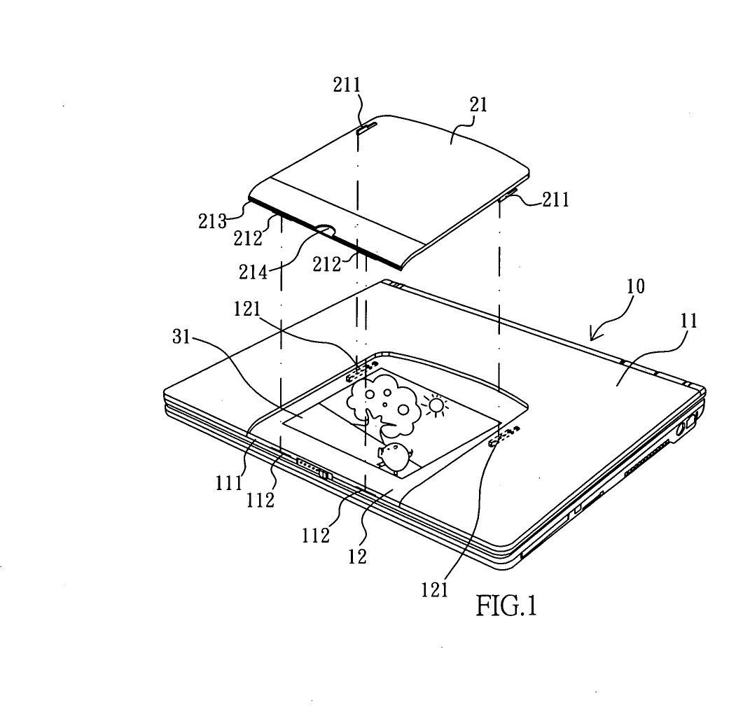

Please refer to FIG. 1. A reconfigurable structure for a panel of a portable personal computer of a first preferred embodiment according to the present invention is adapted to couple to the panel of a portable personal computer housing and comprises a portable personal computer 10, a panel 11 at the back of a display screen of the housing thereof in which the panel 11 is provided with an attachment surface 12 indented downward. The attachment surface 12 is extended to one flank side 111 of the panel 11; the attachment surface 12 is provided with a plurality of first buckling portions such as buckling holes 121; at least one third buckling portions such as a buckling holes 112 are disposed on the flank side 111 of the panel 11; a cover plate 21 with a dimension corresponding to the attachment surface 12 is used for coupling to the panel 11; second and fourth buckling portions such as fasteners 211,212 corresponding to the buckling holes 121,112 are respectively disposed on the cover plate 21 and the fasteners 211, 212 are respectively extended from the underside of the cover plate 21 to the same side.

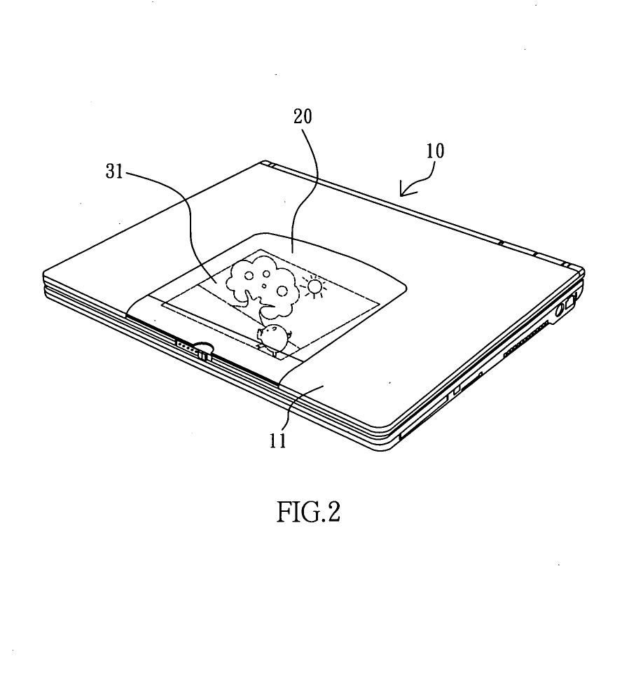

Please refer to FIGS. 1, 2. When the present embodiment is put into practice, the thin article 31 such as picture or document is placed on the top of the attachment surface 12 of the panel 11 of the portable personal computer 10, then take the cover plate 21 to install on the top of the attachment surface 12 to cover the thin article 31, and then to move the cover plate 21 to cause the fasteners 211, 212 respectively to fasten the buckling holes 121, 112. Therefore, the cover plate 21 can couple the attachment surface 12 and cause the thin article 31 is sandwiched between the cover plate 21 and the attachment surface 12.

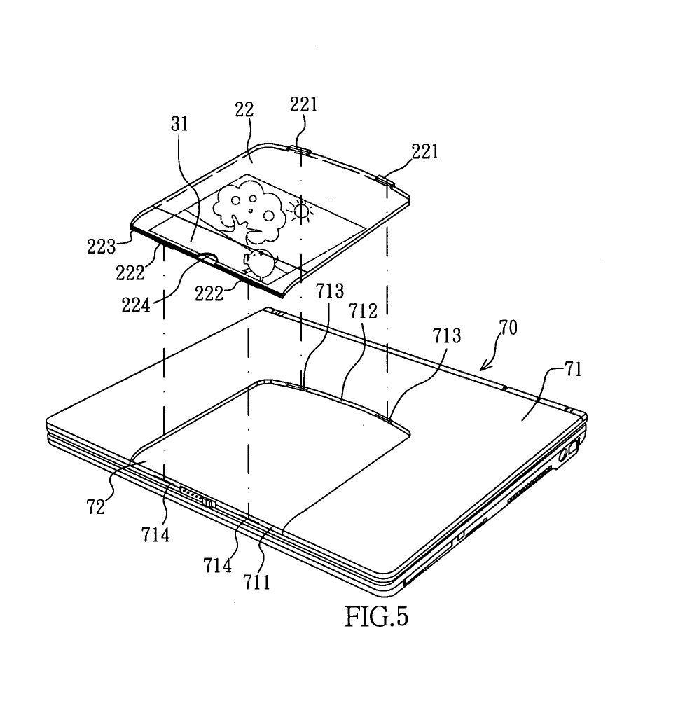

A slit chamber receiving space 213 used for accepting a thin article 31 such as graph or document is disposed in the cover plate 21 of the present embodiment. Besides, an indented-inward arc indentation 214 is disposed at an opening of the receiving space 213 so as to be convenient for a user to take out the thin article 31 through the arc indentation 214. When the present embodiment is put into practice, the thin article 31 is placed into the receiving space 213 through the opening of the receiving space 213 as FIG. 5 shows.

The cover plate 21 of the present embodiment can be a transparent plate, be provided with different length and width, or allow a brand name or trademark to be disposed on the cover plate 21. After the cover plate 21 is fixed on the panel 11, the pattern is exposed through the transparent cover plate 21 depending on the pattern placed-in thin article 31 or the cover plate 21 is provided with a different decoration pattern to allow an outlook of a housing of the portable personal computer 10 to be formed with a different modeling or pattern. The cover plate 21 of the present embodiment can also be provided with a writable and erasable plate such as a whiteboard to offer a user an erasable writing plate surface.

Please refer to FIG. 2. According to the present embodiment, the thin article 31 such as picture or document can be placed in a slit between the cover plate 21 and the panel 11 and can be taken out anytime conveniently so as to allow the different thin article 31 to be changed to attain to the personalized change requirement or the different cover plate 21 to be replaced to match up with the requirement of a different purchaser.

According to the present embodiment, the cover plate 21 is conveniently coupled onto the panel 11. The portable personal computer 10 is allowed to provide with a different personalized style of modeling of the panel to attain to the outlook changing effect by means of a design of the cover plate 21 with a different pattern.

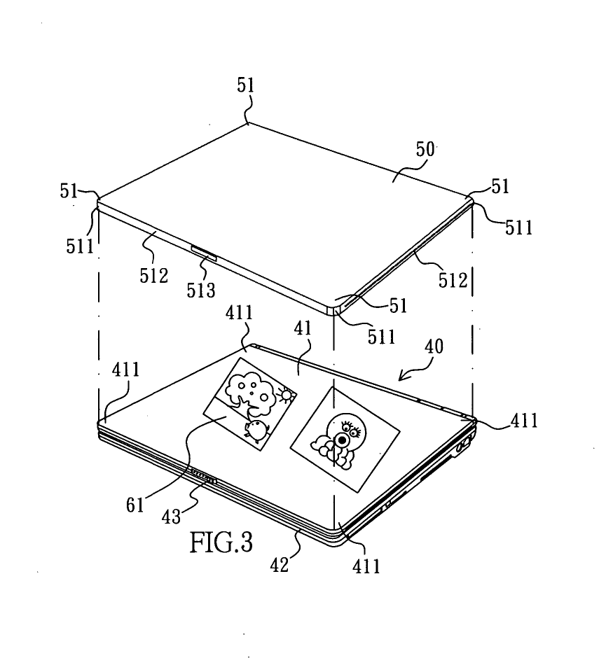

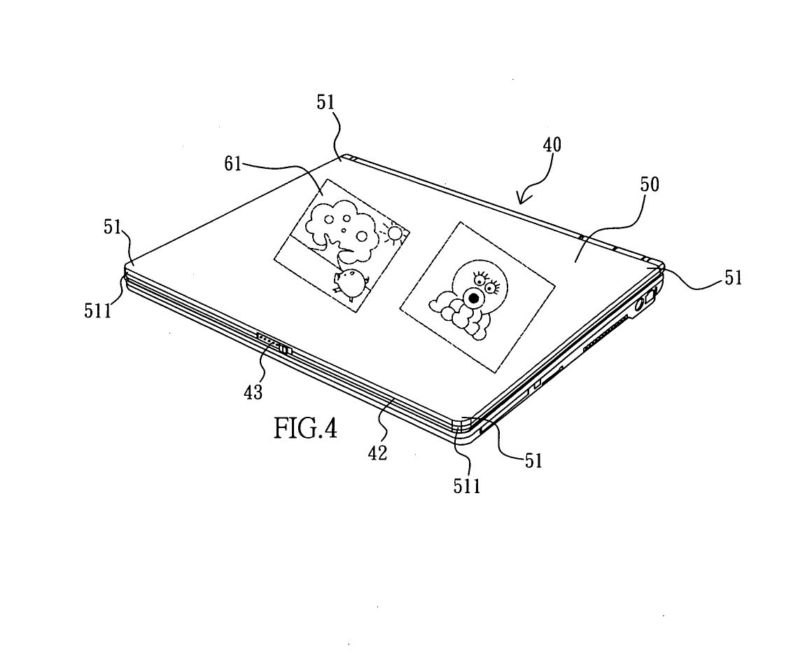

Please refer to FIGS. 3, 4. A reconfigurable structure for a panel of a portable personal computer of a second preferred embodiment according to the present invention is allowed the entire top planar surface of the panel 41 of the portable personal computer 40 to form an attachment surface, and four corners 411 of the panel 41 to act as first buckling portions; and four corners 51 of the cover plate 50 to act as second buckling portions 511 such as an interlocking wall corresponding to the shape of the four corners 411 of the panel 41 respectively which are extended downward and can wrap the two set of the flanks at the four corners 411. Further allows the interlocking wall of the four second buckling portions 511 of the cover plate 50 to connect with each other causes the surroundings of the cover plate 50 provide a downward bending side wall 512. The side wall 512 is provided with a hole 513 which corresponds to a buckle-switch 43 place of the panel 41 and the pedestal 42 of the portable personal computer 40.

Please refer to FIGS. 3, 4. When the present embodiment is put into practice, a thin article 61 such as picture or document can be placed on the top planar surface of the panel 41 of the portable personal computer 40, then cause the second buckling portion 511 of the four corners of the cover plate 50 to fasten the two sides of the four corners of the panel 41 of the portable personal computer 40. Therefore, the cover plate 50 can be coupled to the top planar surface of the panel 41, and the thin article 61 is sandwiched between the cover plate 50 and the panel 41, and the buckle-switch 43 is exposed to the outside of the hole 513. It is convenient for a user to operate the buckle-switch 43. The material of the cover plate 50 of the present embodiment and the contents disposed thereon are the same as the cover plate 21 in the first embodiment. It can achieve the technical effects similar to the first embodiment.

Please refer to FIG. 5. A reconfigurable structure for a panel of a portable personal computer of a third preferred embodiment according to the present invention comprises a portable personal computer 70, a panel 71 at the back of a display screen of a housing thereof in which the panel 71 is provided with an attachment surface 72 indented downward. The attachment surface 72 is extended to one flank side 711 of the panel 71. A junction of the attachment surface 72 and the panel 71 is provided with a protruding wall 712; the wall 712 is provided with a plurality of first buckling portions such as buckling holes 713; at least one third buckling portions such as buckling holes 714 is disposed on the flank side 711 of the panel 71; a cover plate 22 with a dimension corresponding to the attachment surface 72 is used for coupling to the panel 71; second and fourth buckling portions such as fasteners 221,222 corresponding to the buckling holes 713,714 are respectively disposed on the cover plate 22 and the fasteners 221, 222 are respectively extended from the underside of the cover plate 22 to the same side. A slit chamber receiving space 223 used for accepting a thin article 31 such as graph or document is disposed in the cover plate 21 of the present embodiment. Besides, an indented-inward arc indentation 224 is disposed at an opening of the receiving space 223 so as to be convenient for a user to take out the thin article 31 through the arc indentation 224.

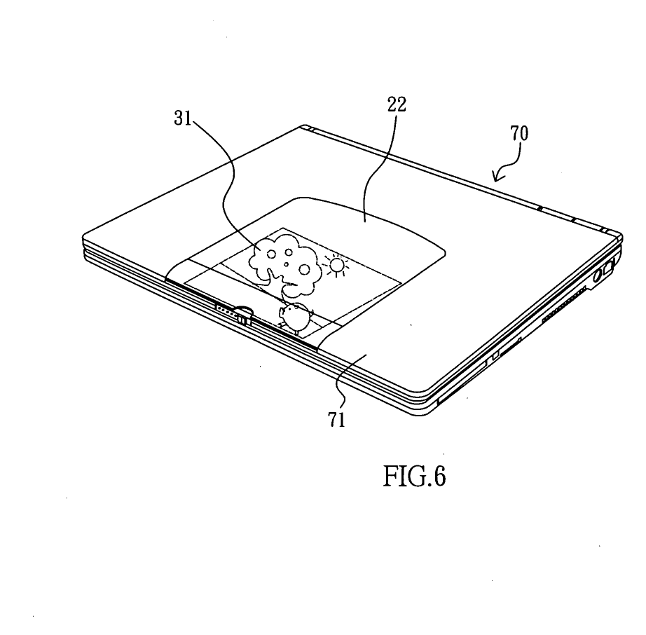

Please refer to FIGS. 5, 6. When the present embodiment is put into practice, the thin article 31 such as picture or document is placed on the top of the attachment surface 72 of the panel 71 of the portable personal computer 70, then take the cover plate 22 to install on the top of the attachment surface 72 to cover the thin article 31, and then to move the cover plate 22 to cause the fasteners 221, 222 respectively to fasten the buckling holes 713, 714. Therefore, the cover plate 22 can couple the attachment surface 72 and cause the thin article 31 is sandwiched between the cover plate 22 and the attachment surface 72. Or, it can take the thin articles 31 such as pictures and documents, and place them into a receiving space 223 of the cover plate 22 through the opening of the receiving space 223, and exposes the pattern of the thin articles 31. In this embodiment, the material of the cover plate 22 and the upper contents thereon are the same as the cover plate 21 of the first embodiment. It can achieve the technical effects similar to the first embodiment.

A reconfigurable structure for a panel of a portable personal computer disclosed in the present invention allows an outlook, pattern or material of the panel of the computer to be changed to attain to the requirement the outlook of the computer is matched up with the personalized desire so as to stimulate consumers' desire to purchase. Besides, a computer manufacturer can provide different purchaser with a same type of computer with different outlooks by means of the reconfigurable structures for a panel of a portable personal computer disclosed in the present invention. This is also to say that only changing a cover plate or a place-in pattern can change the outlook to attain to the growth of the production and the sale amounts of a same fundamental type of product without needing to respectively manufacture different outlook and modeling of products so as to be able to save the production cost greatly and increase the profit of the computer manufacturer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reconfigurable structure for a panel of a portable personal computer, adapted to couple to said panel of a portable personal computer housing and comprising:
said panel of said portable computer housing having an attachment surface; said panel is provided with a plurality of first buckling portions;
a cover plate, the dimension thereof is corresponding to the attachment surface; the cover plate is provided with a plurality of second buckling portions respectively corresponding to the first buckling portions;
wherein, the first and the second buckling portions are further allowed to engage with each other; the cover plate to be positioned on the attachment surface of the panel; whereby, a user is allowed to choose a required cover plate, and the cover plate is allowed to be fixed on the panel of the portable computer housing.

2. The reconfigurable structure for a panel of a portable personal computer according to claim 1, wherein the attachment surface is extended to a flank side of the panel.

3. The reconfigurable structure for a panel of a portable personal computer according to claim 2, wherein the panel is provided with the attachment surface indented downward; the attachment surface is provided with the first buckling portion.

4. The reconfigurable structure for a panel of a portable personal computer according to claim 2, wherein the panel is provided with the attachment surface indented downward; the attachment surface is provided with the first buckling portion; a junction between the attachment surface and the panel is provided with a protrusive wall which is provided with the first buckling portion.

5. The reconfigurable structure for a panel of a portable personal computer according to claim 3, wherein the flank side of the panel is provided with at least a third buckling portion; the cover plat is provided with a fourth buckling portion which corresponds to the third buckling portion; whereby, the third and the fourth buckling portions are further allowed to engage with each other.

6. The reconfigurable structure for a panel of a portable personal computer according to claim 5, wherein the cover plate is a transparent plate; the cover plate is provided with a receiving space used for receiving a thin article.

7. The reconfigurable structure for a panel of a portable personal computer according to claim 6, wherein an indented inward indentation is disposed at an opening of the receiving space of the cover plate; whereby, a user is allowed to take out the thin article placed in the receiving space through the indentation.

8. The reconfigurable structure for a panel of a portable personal computer according to claim 3, wherein the cover plate is a transparent plate; a slit exists between the cover plate and the attachment surface; whereby, the slit is used to allow a thin article to be held between said cover plate and said panel.

9. The reconfigurable structure for a panel of a portable personal computer according to claim 5, wherein the second buckling portion and the fourth buckling portion of the cover plate are respectively extended to the same side which beneath the cover plate.

10. The reconfigurable structure for a panel of a portable personal computer according to claim 9, wherein the second and fourth buckling portions of the cover plate and the first and third buckling portions of the panel are respectively the corresponding fasteners and buckling holes.

11. The reconfigurable structure for a panel of a portable personal computer according to claim 5, wherein the cover plate is provided with a writable and erasable plate surface so as to offer a user an erasable writing plate surface.

12. The reconfigurable structure for a panel of a portable personal computer according to claim 5, wherein the top planar surface of the cover plate is provided with one of a brand name, logo and a decorative design.

13. The reconfigurable structure for a panel of a portable personal computer according to claim 1, wherein the entire top planar surface of the panel to form the attachment surface; four corners of the panel to form the first buckling portions; the four corners of the cover plate respectively is provided with an interlocking wall which is extended downward and wraps two sides of the four corners, to form a second buckling portion which corresponds to the shape of the four corners.

14. The reconfigurable structure for a panel of a portable personal computer according to claim 13, wherein the cover plate is a transparent plate; a slit exists between the cover plate and the attachment surface; whereby, the slit is used to allow a thin article to be held between said cover plate and said panel.

15. The reconfigurable structure for a panel of a portable personal computer according to claim 13, wherein the cover plate is provided with a writable and erasable plate surface so as to offer a user an erasable writing plate surface.

16. The reconfigurable structure for a panel of a portable personal computer according to claim 13, wherein the top planar surface of the enclosure penal is provided with one of a brand name, logo and a decorative design.

17. The reconfigurable structure for a panel of a portable personal computer according to claim 13, wherein the four interlocking walls of the second buckling portion of the cover plate are inter-connected to form a downward bended side wall which surrounds the cover plate.

18. The reconfigurable structure for a panel of a portable personal computer according to claim 14, wherein the four interlocking walls of the second buckling portion of the cover plate are inter-connected to form a downward bended side wall which surrounds the cover plate.

19. The reconfigurable structure for a panel of a portable personal computer according to claim 15, wherein the four interlocking walls of the second buckling portion of the cover plate are inter-connected to form a downward bended side wall which surrounds the cover plate.

20. The reconfigurable structure for a panel of a portable personal computer according to claim 17, wherein the side wall has a hole; the hole corresponds to a buckle-switch place of the panel and the pedestal of the portable personal computer.
